(19) United States
(12) Patent Application Publication
(10) Pub. No.: US 2024/0331022 A1
(43) Pub. Date: Oct. 3, 2024

(54) Modifying Time-Specific Components of Property Listings Simultaneously

(71) Applicant: Turo Inc., San Francisco, CA (US)

(72) Inventors: Emily Jana Tucker, San Francisco, CA (US); Loretta May Widen, Pleasant Hill, CA (US); Qin Bian, San Francisco, CA (US); Renu Srinivasan, Santa Clara, CA (US); Matt Mert Ozer, San Francisco, CA (US)

(73) Assignee: Turo Inc., San Francisco, CA (US)

(21) Appl. No.: 18/229,729

(22) Filed: Aug. 3, 2023

Related U.S. Application Data
(60) Provisional application No. 63/493,427, filed on Mar. 31, 2023.

(51) Int. Cl. G06Q 30/0645; G06Q 10/1093

(52) U.S. Cl. CPC G06Q 30/0645; G06Q 10/1093

(57) ABSTRACT

In implementation of techniques for modifying time-specific components of property listings simultaneously, an application receives data describing property listings with time-specific components. Based on the data, the application generates and renders an interactive scheduling interface, including a calendar visual. The calendar visual presents schedules of the property listings and includes visuals representing the time-specific components. The application receives user input selecting a time-specific modification to apply to different property listings for the different time periods. Based on the user input, the application applies the time-specific modifications to the different property listings for the different time periods simultaneously and updates the visuals of the interactive scheduling interface to represent the time-specific modifications applied.

### RELATED APPLICATION

This application is a non-provisional application and claims the benefit of and priority to U.S. Provisional Application No. 63/493,427, filed Mar. 31, 2023, the entire disclosure of which is incorporated herein by reference.

### BACKGROUND

Early conventional techniques for hosting properties, such as via property rental companies, often provide little flexibility to hosts of properties. This inflexibility led to the increasing popularity of recent conventional techniques for hosting properties, in which the hosts provide access to their properties via online platforms instead and have greater flexibility to individualize the property listings made accessible via the online platforms.

However, the recent conventional techniques fall short in addressing challenges arising from this greater flexibility. For example, the recent conventional techniques fail to provide a way for a host account to simultaneously view and modify various time-specific components of multiple property listings in a single centralized location. The recent conventional techniques lack the ability to display the various time-specific components of the multiple listings in a way that enables the host account to take appropriate action to effectively modify the multiple listings. As another example, the recent conventional techniques fail to enable effective collaborative modification of multiple property listings by multiple host accounts simultaneously.

Because the recent conventional techniques fail to address the challenges of flexible property hosting via online platforms, the recent conventional techniques can result in negative outcomes in some instances, such as a burdened host account experience and wasted computational power, storage, and transmission resources.

### SUMMARY

Techniques and systems for modifying time-specific components of property listings are described. In an example, a computing device receives data describing property listings and time-specific components corresponding to the property listings and generates an interactive scheduling interface based on the data. The scheduling interface includes a calendar visual that presents schedules of the property listings and includes visuals representing the time-specific components.

The computing device renders the scheduling interface for display via a user interface and receives user input selecting different time periods and time-specific modifications for different property listings. Based on the user input and data, the computing device generates modified data by applying the time-specific modifications to the data describing the property listings for the different time periods, updating the visuals to modified visuals to represent the modified time-specific components simultaneously. The modified visuals are rendered for display via the user interface as part of the calendar visual and the interactive scheduling interface.

These techniques and systems enable enhanced viewing and modification of property listings of the online platform by enabling one or more host accounts to simultaneously modify time-specific components of the property listings across different time periods through the interactive scheduling interface.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ techniques and systems for modifying time-specific components of property listings simultaneously, as described herein.

FIG. 2 depicts a system in an example implementation showing operation of the listing manager module for modifying time-specific components of property listings simultaneously by rendering a scheduling interface.

FIG. 3 depicts a system in an example implementation showing operation of a listing manager module for generating and rendering modified visuals based on user input, in which the modified visuals represent modified time-specific components of property listings.

FIG. 4 depicts a system in an example implementation showing operation of a listing manager module for modifying time-specific components of property listings simultaneously based on modification data and by rendering modified visuals representing the modified time-specific components corresponding to the property listings.

FIG. 5 depicts an example of rendering a scheduling interface including a calendar visual, in which the calendar visual presents schedules of property listings corresponding to a host account of an online platform.

FIG. 6 depicts an example of a scheduling interface, in which the scheduling interface includes a plurality of selectable sorting options to apply to schedules of property listings presented by a calendar visual of the scheduling interface.

FIG. 7 depicts an example of a scheduling interface including a plurality of selectable filtering options to apply to schedules of property listings presented by a calendar visual of the scheduling interface.

FIG. 8 depicts an example of user input selecting time periods for property listings for modification via a scheduling interface.

FIG. 9 depicts an example of a scheduling interface and a calendar visual after applying simultaneous modifications to time-specific components of property listings based on user input.

FIG. 10 depicts a procedure in an example implementation of modifying time-specific components of property listings simultaneously.

FIG. 11 illustrates an example system including various components of an example device that can be implemented as any type of computing device as described and/or utilized with reference to FIGS. 1-10 to implement embodiments of the techniques described herein.

### DETAILED DESCRIPTION

### Overview

Traditional property rental companies often imposed rigid constraints on hosts, limiting their control over aspects such as pricing, availability, and booking terms. With the advent of online property hosting platforms, host accounts have more autonomy and flexibility in managing property listings. However, the conventional techniques associated with online property hosting platforms have not adequately addressed the complexities that stem from this increased flexibility.

By way of example, the conventional techniques provide host accounts with numerous different interfaces for managing different aspects of each property listing, resulting in a fragmented and time-consuming management process. This management process is further frustrated by the absence of a comprehensive, enhanced interface that includes these different aspects and is particularly suited for common small user interfaces, such as the small user interfaces of ubiquitous smart phones. Moreover, the lack of integration between different property listings can lead to inefficient utilization of available inventory, missed opportunities for revenue optimization, and a suboptimal user experience for host accounts.

Furthermore, existing property hosting platforms have not adequately addressed the need for seamless collaboration among multiple host accounts. The absence of a unified, enhanced user interface to facilitate real-time collaboration on multiple property listings results in redundant efforts, miscommunication, and inconsistencies in managing time-specific components across property listings. Additionally, these property hosting platforms fail to provide data-driven decision-making in many instances, because the conventional techniques used by the property hosting platforms fail to provide comprehensive visualization tools that empower the host accounts in making informed adjustments to the property listings of the host accounts. Consequently, the limitations of conventional property hosting techniques lead to negative outcomes, such as diminished user satisfaction and wasted computational power, storage, and transmission resources.

Techniques and systems for modifying time-specific components of property listings simultaneously are described that overcome these limitations. In one example, a property hosting application data obtains data describing one hundred property listings associated with a host account of the property hosting application. The data includes time-specific components of the one hundred property listings, such as the prices of reserving the one hundred property listings across time. The host account intends to increase the price of two specific property listings, namely a Tesla Model X vehicle and a Tesla Model S vehicle, during selected winter holiday periods by 5%.

To facilitate this intention, a scheduling interface including a calendar visual is generated based on the data. The scheduling interface is an enhanced user interface that enables the host account (and other host accounts managing the property listings via different computing devices) to view a visual representation of the schedules of the one hundred property listings. The visual representation of the schedules includes visuals representing the time-specific components of the listings. In some examples, a visual (e.g., a black solid bar) spanning a time period and corresponding to a property listing is configured to represent a status of the property listing during the time period. Examples of the status of the property listing includes an available property listing that is not yet reserved but is available for reservation by a guest account, a confirmed reserved or booked property listing that is reserved by a guest account and therefore is not available for reservation, an unconfirmed reserved or booked property listing that is reserved by a guest account and therefore is not available for reservation, an unavailable property listing that is not reserved or available for reservation by a guest account, and other types of statuses. The schedules of the one hundred property listings and visuals associated with the one hundred property listings, is easily viewable via computing devices, such as via a small user interface of a common, petite smartphone. The scheduling interface is rendered for display via the user interface of the computing device, enabling the host account to interact with the calendar visual and to provide user input for modifying the property listings.

To continue this example, the calendar visual depicts that the Tesla Model X is already booked for Christmas Eve and Christmas Day but is available for New Year's Eve and New Year's Day. Consequently, the host account selects the latter time period for the Tesla Model X listing. Conversely, the Tesla Model S is available for Christmas Day, Christmas Eve, and New Year's Day but is booked on New Year's Eve. As such, the host account selects the time period encompassing Christmas Day, Christmas Eve, and New Year's Day for the Tesla Model S listing. The host account then provides user input to increase the pricing by 5% for the selected respective time periods for both property listings. In some examples, the host account provides user input to apply the modifications simultaneously to the property listings based on the selections.

To continue this example, the property hosting application receives user input to apply the modification of a 5% increase of pricing for the time period encompassing Christmas Day, Christmas Eve, and New Year's Day for the Tesla Model S listing, in addition to New Year's Eve and New Year's Day for the Tesla Model X listing. The property hosting application subsequently generates modified property listings based on the user input and received data, incorporating the modified time-specific components, such as the adjusted pricing for the respective time periods, into the property listings simultaneously.

These modifications are reflected via modified visuals of the scheduling interface and the calendar visual of the property hosting application, in addition to the property listings for the Tesla Model S listing and the Tesla Model X listing respectively. Consequently, the enhanced user interface of the scheduling interface and the calendar visual enables the simultaneous modification of the time-specific components of the property listings.

Unlike the conventional techniques for property hosting, in some implementations of the techniques described herein for simultaneously modifying date-specific components of the property listings, the described techniques enable modification of time-specific components of the property listings for different combinations of dates for the property listings across a plurality of entities, such as a plurality of property hosting platforms, a plurality of property hosting applications, a plurality of the host accounts, and so forth. Further, unlike the conventional techniques for property hosting, the described techniques for modifying the time-specific components of the property listings also enable flexible editing of the time-specific components of the property listings in addition to the previously noted, unconventional selection patterns. In some implementations, the described techniques herein for modifying the time-specific components of the property listings also enable multi-account collaboration by one or more host accounts on simultaneously selecting and applying modifications to the property listings across the time periods selected.

Overall, the enhanced user interface of the scheduling interface addresses the issues of conventional property hosting, such as diminished user satisfaction and wasted computational power, storage, and transmission resources. Instead, the enhanced user interface of the scheduling interface results in increased user satisfaction, and more efficient use of computational power, storage, and transmission resources.

The enhanced user interface of the scheduling interface also provides a specific and practical solution to the problem of limited display area on electronic devices used by host accounts to implement simultaneous modifications to the time-specific components of the property listings. As such, the enhanced user interface of the scheduling interface results in a more computationally efficient and user-friendly interface.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

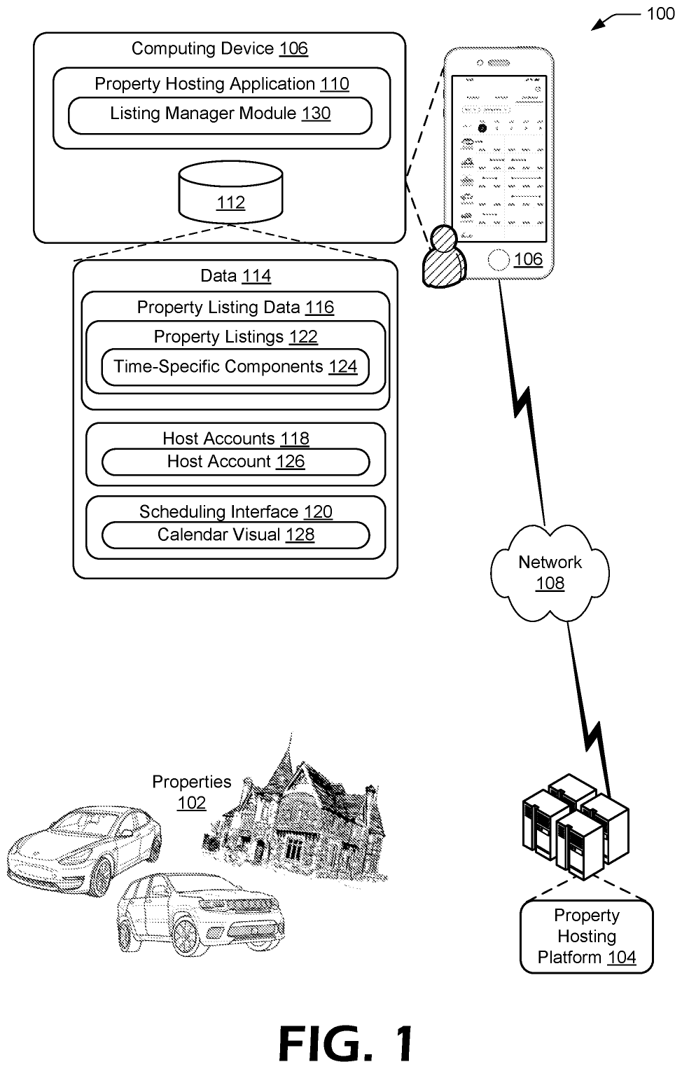

FIG. 1 is an illustration of a digital medium environment 100 in an example implementation that is operable to employ techniques and systems for modifying time-specific components of property listings simultaneously, as described herein. The illustrated environment 100 includes properties 102, a property hosting platform 104, and a computing device 106. In various implementations, the computing device 106 and the property hosting platform 104 are communicatively connected, such as via a network 108.

Example properties 102 include but are not limited to vehicles, entire homes and apartments, private and shared areas (e.g., rooms), unique accommodations such as treehouses and castles, boutique hotels, and so forth. Examples of the vehicles of the properties 102 include any type of vehicle, including but not limited to sedans, coups, sports cars, station wagons, hatchbacks, convertibles, sport-utility vehicles, minivans, pickup trucks, fire engines, tanks, monster trucks, art cars, RVs, ambulances, buses, caravans, mobile homes, coaches, jeeps, double decker buses, formula cars, planes, trains, bulldozers, backhoes, boats, limousines, minibuses, delivery vans, school buses, taxis, streetcars, rickshaws, quads, wagons, mail trucks, excavators, crane trucks, dump trucks, fuel trucks, front loaders, cement mixer trucks, autonomous vehicles, electric vertical takeoff and landing vehicles, skid steer loaders, road rollers, forklifts, tractors, subways, trains, jets, float planes, gliders, helicopters, biplanes, airships, jet fighters, barges, battleships, catamarans, cargo ships, ferries, gondolas, hovercrafts, motorboats, yachts, moto scooters, mopeds, motorbikes, tricycles, scooters, hot air balloons, aerial tramways, carriages, bullock carts, snow mobiles, hoverboards, and manned drones, to name just a few.

The computing device 106 is configurable as a desktop computer, a laptop computer, a mobile device (e.g., assuming a handheld configuration such as a tablet or mobile phone), wearable devices, and so forth. Thus, the computing device 106 is capable of ranging from a full resource device with substantial memory and processor resources (e.g., personal computers, game consoles) to a low-resource device with limited memory and/or processing resources (e.g., mobile devices). In some examples, the computing device 106 is representative of a plurality of different devices such as multiple servers utilized to perform operations “over the cloud.”

The computing device 106 includes a property hosting application 110 and a storage device 112 that is illustrated to include data 114, such as property listing data 116, host accounts 118, and a scheduling interface 120. The property listing data 116 includes property listings 122, however other types of property listing data 116 are imagined, such as data identifying host accounts associated with the property listings 122. The property listings 122 include time-specific components 124, such as pricing, season, day of the week, minimum and maximum stay requirements, peak travel periods, availability, property listing status, and so forth.

Broadly speaking, the property hosting application 110 is configured to support interactions with the host accounts 118 that enable efficient modification of the property listings 122. By way of example, the property hosting application 110 is configured to support collaborative modification of the property listings 122 by the host accounts 118. In various implementations, user input from the host accounts 118 is received via the scheduling interface 120 to manipulate the scheduling interface 120 for more efficient modification of the property listings 122, to simulate modifications to the schedules of the property listings 122, to apply modifications to the property listings 122, including the property listings 122, and so forth.

The host accounts 118 include a host account 126, which the scheduling interface 120 is configured based on in part to include a calendar visual 128 presenting schedules of property listings 122 hosted or co-hosted by the host account 126. The scheduling interface 120 (including the calendar visual 128) is an enhanced, interactive user interface that provides various functionality to facilitate effective modification of the time-specific components 124 of the property listings 122 for different time periods. By way of example, the scheduling interface 120 is navigable in various directions, such as in horizontal and vertical directions. In some implementations, the calendar visual 128 and the scheduling interface 120 are configured to enable the host account 126 to pull down on any obscuring elements, such as a part of the scheduling interface 120 (e.g., a component modification window, such as a price modification window) that is obscuring the calendar visual 128, such that the calendar visual 128 is less obscured, and such that the host account 126 can better interact with the calendar visual 128.

The calendar visual 128 is configured to provide the schedules of the property listings 122 in an efficient and visual manner via the inclusion of relevant properties of the property listings 122, such as images representing the property listings 122, visuals representing the time-specific components 124 of the property listings 122, and so forth. In some examples, the calendar visual 128 provides various calendar views, such as day, week, month, year, agenda, three-month, work week, and so forth. By way of example, the week view of the calendar visual 128, the calendar visual 128 includes a plurality of cells in which each cell represents a day of a schedule of a property listing of the property listings 122. In some implementations, the calendar visual 128 displays the properties of the property listings 122 of the host account 126, availability (or unavailability) of the properties of the property listings 122 of the host account 126, and reservations (e.g., booked trips) of the properties of the property listings 122 in the single enhanced user interface of the scheduling interface 120.

The scheduling interface 122 and the calendar visual 128 are configured to support collaborative modifications by a plurality of the host accounts 126. In some examples, the calendar visual 128 and the scheduling interface 120 enable the host accounts 118 to view changes being made to the calendar visual 128 and the scheduling interface 120 in real time, such as non-adjusted time-specific components 124 of the property listings 122 and adjusted time-specific components 124 of the property listings 122, and so forth.

In some implementations, the listing manager module 130 of the property hosting application 110 is configured to receive user input and to apply corresponding actions based on the user input to the scheduling interface 120 and/or the property listings 122 (e.g., the time-specific components 124 of the property listings 122). The listing manager module 130 is configured to provide host accounts 126 with high flexibility of selection of features of the scheduling interface 120 and the calendar visual 128. In various examples, the listing manager module 130 is configured to receive user input from host accounts 126 to select any combination of individual or multiple days across one, multiple, or all property listings 122 via the scheduling interface 120. By way of example, the listing manager module 130 is configured to receive user input selecting various non-consecutive days of a first property listing, a duration of multiple weeks for a second property listing, and one date for all of the property listings 122, of which the time periods and the respective property listings of the property listings 122 are selected for simultaneous modifications.

Once the listing manager module 130 receives the selections of the time periods for the respective property listings selected, the listing manager module 130 is configured to receive additional user input to modify the corresponding one or more of the time-specific components 124 for the time periods for the respective property listings selected. In various implementations, the modifications are not instantly applied, but are instead simulated via the scheduling interface 120 until the modifications are applied to the property listings 122 via a user input by a host account 126 via the scheduling interface 120. In some examples, before applying the modifications to the property listings 122, the scheduling interface 120 displays the current, unchanged versions of the time-specific components 124 in addition to a modified version of the time-specific component in which the time-specific components 124 reflect the modifications to be applied.

In some implementations, the listing manager module 130 is configured to support collaboration on the schedules of the property listings 122 via the scheduling interface 120. In some examples, modifications made by one host account 126 are not applied to the property listings 122 without user input approving the modifications by one or more of the other host accounts 118 that are co-hosts of the property listings 122. Examples of other collaborative features of the listing manager module 130 include but are not limited to communicating (to the host accounts 118) one or more notifications of modifications applied to the property listings 122, simultaneous editing of the property listings 122 by the host accounts 118, visual representations of the proposed changes selected by the host accounts 118 in real time, preventing alterations by other host accounts 118 to a proposed modification to a period of time for a property listing 122 selected by the host account 126, and so forth.

In accordance with the described techniques, the property hosting application 110 is configured to utilize a listing manager module 130 to configure and cause output of the scheduling interface 120 and the calendar visual 128. The listing manager module 130 may configure the scheduling interface 120, for instance, and the property hosting application 110 may cause display of the configured scheduling interface 120 via a display device of the computing device 106. By way of example, the listing manager module 130 may configure the scheduling interface 120 based on the property listing data 116 to include the schedules of the property listings 122 in addition to various functionality to sort, filter, and/or modify the property listings 122.

In one or more implementations, the property hosting application 110 leverages resources of the property hosting platform 104 in connection with scheduling interface 120 and the calendar visual 128. By way of example, the property hosting platform 104 may be configured to store data, such as the property listing data 116. In one or more implementations, the host account 126 is a user account of the property hosting application 110, the computing device 106, or the property hosting platform 104. The property hosting platform 104, in some examples, is configured to provide updates and/or additions to the property hosting application 110.

Further still, the property hosting platform 104 may train, maintain, and/or deploy algorithms (e.g., machine learning algorithms) to generate predictions in connection with modifying the property listings 122, such as by using the data 114. One or more such algorithms may require an amount of computing resources that exceeds the resources of typical, personal computing devices, e.g., mobile phones, laptops, tablet devices, and wearables, to name just a few. Nonetheless, the property hosting platform 104 may include or otherwise have access to the amount of resources needed to operate such algorithms, e.g., cloud storage, server devices, virtualized resources, and so forth. The property hosting platform 104 may provide a variety of resources that the property hosting application 110 leverages in connection with modifying the property listings 122, including the time-specific components 124 of the property listings 122.

In general, functionality, features, and concepts described in relation to the examples above and below are employed in the context of the example procedures described in this description. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

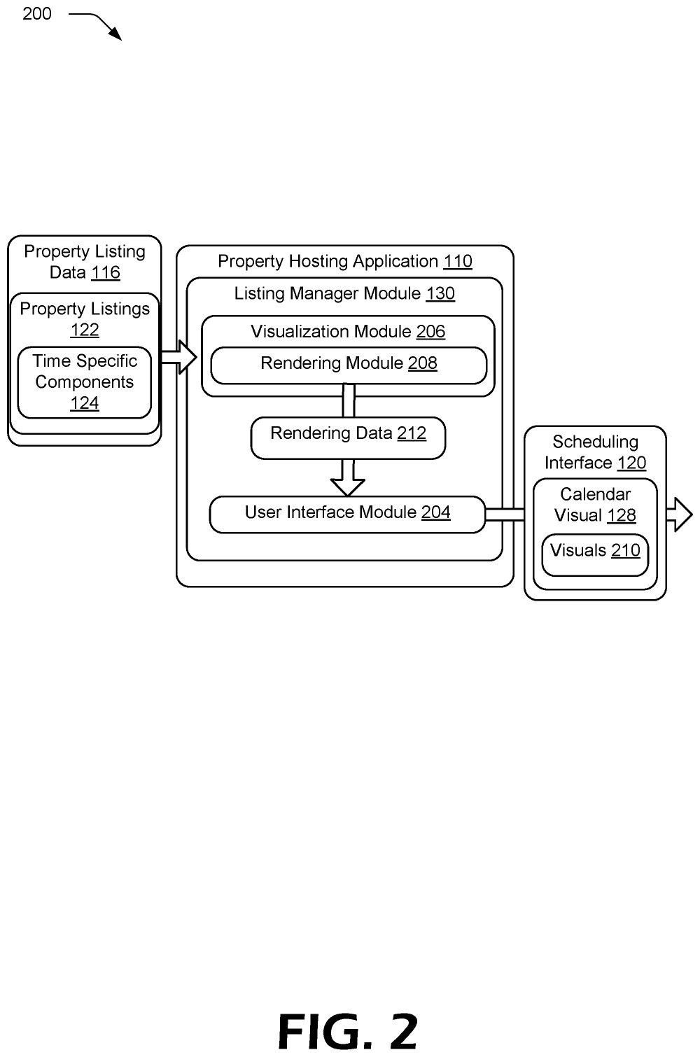

As discussed above and below, various modifications can be simulated or applied to the property listings 122 via the scheduling interface 120 in accordance with the described techniques. In the context of modifying time-specific components 124 of property listings 122 simultaneously, consider the following discussion of FIG. 2.

### Modifying Time-Specific Components of Property Listings Simultaneously

The following discussion describes techniques that are implementable utilizing the previously described systems and devices. Aspects of each of the procedures are implemented in hardware, firmware, software, or a combination thereof. The procedures are shown as a set of blocks that specify operations performed and/or caused by one or more devices and are not necessarily limited to the orders shown for performing the operations by the respective blocks. In portions of the following discussion, reference is made to FIGS. 1-11.

FIG. 2 depicts a system 200 in an example implementation showing operation of a listing manager module 130 for modifying time-specific components 124 of property listings 122 simultaneously by generating and rendering a scheduling interface 120 for display via a user interface.

The system 200 includes the property hosting application 110 of FIG. 1, in which the property hosting application 110 includes a listing manager module 130 and a user interface module 204. The listing manager module 130 is configured to facilitate the management of property listings associated with the property hosting application 110. The listing manager module 130 is also configured to obtain data 114, including the property listing data 116. The user interface module 204 is configured to receive user input from one or more host accounts 118 and to output the scheduling interface 120 generated and rendered based on the property listing data 116.

The listing manager module 130 includes a visualization module 206, in which the visualization module 206 includes a rendering module 208. The visualization module 206 is configured to generate the scheduling interface 120, the calendar visual 128, and visuals 210 corresponding to the various property listings 122 associated with the property hosting application 110.

To begin in this example, the listing manager module 130 obtains the property listing data 116, in which the property listing data 116 describes the property listings 122 associated with the one or more host accounts 118 of the property hosting application 110. In some implementations, the listing manager module 130 obtains the property listing data 116 as part of the data 114. In this example, among others, the property listing data 116 includes time-specific components 124. Examples of time-specific components 124 include but are not limited to a price of reserving a property listing 122, an availability of a property listing 122, and so forth.

The listing manager module 130 is configured to obtain the property listing data 116 in various ways, including but not limited to receiving the property listing data from the storage device 112 of the computing device 106, from the property hosting platform 104, from a different property hosting application, from a service provider system, and so forth. The listing manager module 130 is further configured to communicate the property listing data to the visualization module 206 for processing.

The visualization module 206 is configured to receive the property listing data 116 from the listing manager module 130. Based on the property listing data 116, the visualization module 206 generates a scheduling interface 120 including a calendar visual 128. The calendar visual 128 presents schedules of the property listings 122 based on the property listing data 116 and includes visuals 210 representing the time-specific components 124 of the property listings.

As part of the visualization module 206, the rendering module 208 generates rendering data 212 corresponding to the scheduling interface 120, the calendar visual 128, and the visuals 210 generated by the visualization module 206. The visualization module 206 is configured to communicate the rendering data 212 to the user interface module 204 to display the scheduling interface 120, the calendar visual 128, and the visuals 210 rendered via a user interface of the computing device 106.

In some examples, the calendar visual 128 includes enhanced scrolling, such that host accounts do not need to wait for each batch of consecutive data (e.g., property listings 122 presented via the calendar visual 128 or dates of the calendar visual 128) to load. The scheduling interface 120 is configured to move the viewed position of the calendar visual 128 via various recognized gestures, such as scrolling or swiping. Once the host account 126 stops at a particular portion of the calendar visual 128 for at least a predefined period of time designated by the property hosting application 110, the property hosting application 110 fetches additional data corresponding to where the host account 126 has stopped, in which the additional data corresponds to the particular portion of the calendar visual 128. As such, in some examples, the host account 126 can begin providing user input to modify time-specific components 124 of the property listings 122 before the fetching of the data is complete. The calendar visual 128 and the scheduling interface 120 enables host accounts 118 to seamlessly navigate across periods of time (e.g., dates) and property listings 122 represented or presented via the calendar visual 128. For example, a user element can be selected via a user input of the host account 126 to navigate to the current date. Further, host accounts 118 can navigate forward or backward over long periods of time via a month-view of the calendar visual 128 by jumping to a chosen date. There are various other techniques to seamlessly navigate across the dates and property listings 122 via the calendar visual 128 and the scheduling interface 120.

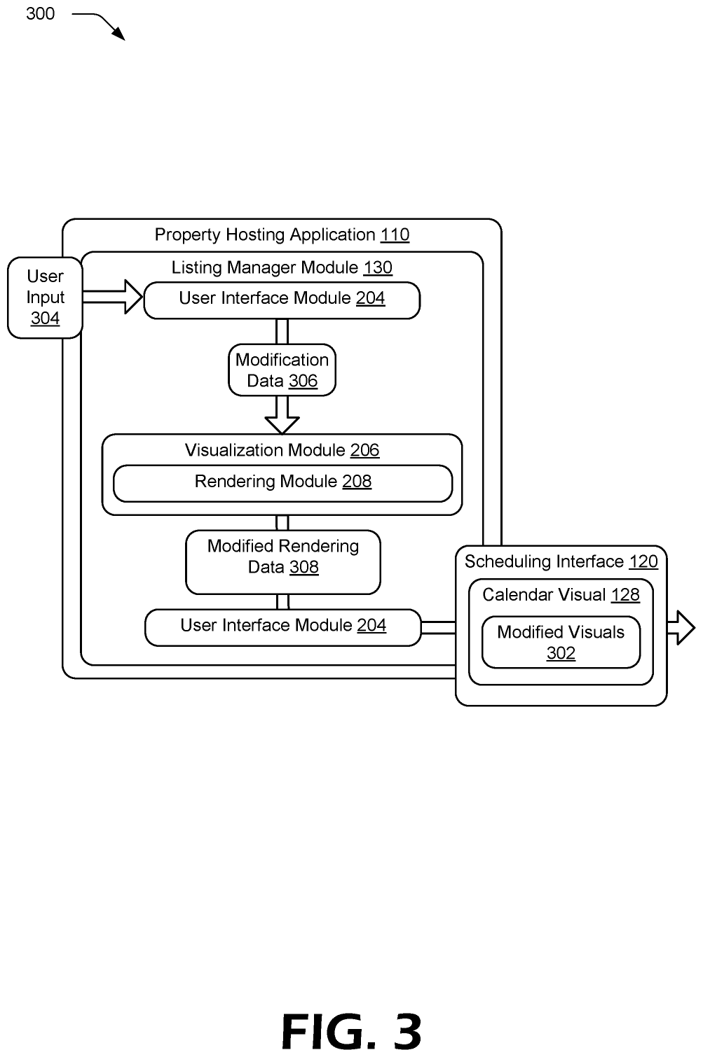

In the context of the scheduling interface 120, the calendar visual 128, and the visuals 210 rendered based on the property listing data 116, consider the following discussion of FIG. 3.

FIG. 3 depicts a system 300 in an example implementation showing operation of the listing manager module 130 for generating and rendering modified visuals 302 based on user input 304 received by the user interface module 204, in which the modified visuals 302 represent modified time-specific components 124 of property listings. The listing manager module 130 includes the user interface module 204, the visualization module 206, and the rendering module 208 of FIG. 2.

To begin this example, the user interface module 204 receives user input 304. As already described in this written description, the user interface module 204 is configured to receive user input 304. The user interface module 204 is configured to manipulate various features of the scheduling interface 120 and the calendar visual 128 (such as sorting features, filtering features, etc.) based on the user input 304 received.

In various implementations, the scheduling interface 120 includes sorting functionality for sorting the property listings 122. In some examples, the scheduling interface 120 includes a plurality of selectable sort options for sorting the schedules of the property listings 122. The sort or sorting options enable more effective management of the property listings by the host accounts 118 by enabling host accounts 118 to modify and maintain an order of the property listings 122. Examples of the sorting options include sorting the property listings by booking popularity, by booking saturation, profitability, ratings, and so forth.

The scheduling interface 120 includes additional functionality to support the sorting features. By way of example, if the host account 126 has already scrolled to a future date, when the host account 126 applies a sorting setting to the property listings 122 of the scheduling interface 120, the host account 126 is kept on the aforementioned future date. In some examples, when the host account 126 applies one of the sorting settings to the scheduling interface 120 or the calendar visual 128, the sorting setting remains applied for the length of the host account's 126 session.

The user interface module 204 is configured to receive a selection of a selectable sorting option of the plurality of selectable sort options via the user input 304. Based on the selection of the selectable sort option via the user input 304, the listing manager module 130 sorts the schedules of the property listings 122.

By way of example, if the user input 304 specifies a sorting option that sorts the property listings 122 by the most booked property listing 122 in a time period, the listing manager module 130 causes the scheduling interface 120 to sort the property listings 122 by how booked a property listing 122 is, to easily adjust time-specific components 124 (e.g., the pricing of the property listing 122 during a period of time) for the lowest utilization property listings 122. If the user input 304 specifies a sorting option that sorts that property listings 122 from the highest price today to the lowest price today via a “today's price” sorting option, the listing manager module 130 causes the scheduling interface 120 to sort the property listings 122 by today's price to easily group property listings 122 to be simultaneously modified or edited together by the host accounts 118.

In various implementations, the scheduling interface 120 and the calendar visual 128 are configured to provide filtering options for the host accounts 118 to efficiently manage and modify a chosen subset of the property listings 122. These filtering options facilitate the organization and presentation of the property listings 122 according to various parameters, such as listing status, property type, location, the host account 126, price, and other specific details. In these various implementations, the scheduling interface 120 offers a wide array of filter or filtering options that enable more effective management and modification of the property listings 122. As part of the filtering feature, the property hosting application 110 is configured to facilitate the simultaneous application of actions and modifications, such as price adjustments, to property listings 122 based on the filters. By way of example, by receiving user input selecting a date at the top of the calendar visual 128, modifications are selected for all of the property listings 122 for that specific date. In some examples, based on a filter applied, the scheduling interface 120 applies settings to only a filtered subset of property listings 122, such that the modifications specified by the user input 304 will be applied only to the filtered and displayed property listings, instead of to all of the property listings 122.

When presented by the scheduling interface 120, the filtering options facilitate the organization and presentation of the property listings 122 according to various parameters, such as listing status, property type, location, host account 126, price, and other specific details. By way of example, a filtering option directed to listing status enables host accounts 118 to modify and view property listings based on the status of the property listings 122, which includes listed, pending, not yet published, unlisted (not appearing in guest account searches), and snoozed (temporarily unlisted) status. By way of a different example, a filtering option directed to property type enables host accounts 118 to sort the property listings 122 by property type, such as by vehicle or other specific subsets of types of the property listings 122.

In various embodiments, the filtering apparatus of the scheduling interface 120 includes a search bar that enables host accounts 118 to filter based on one or more searchable factors, such as a specific combination of vehicle make, model, year, and license plate. The scheduling interface 120 is configured to provide various other filtering options in a vehicular context, such as vehicle type (e.g., all vehicles, luxury, green, electric, convertibles, trucks, vans, small, full size, SUVs, wagons, and so forth), trim level, vehicle license plates, location, property listing price, and so forth. In some examples, the scheduling interface 120 is configured to provide various other filtering options, such as a property types (e.g., all properties, luxury, house, apartment, private room, shared room, unique accommodations, boutique hotel, boat, vehicle, etc.), by included amenities (e.g., Wi-Fi, air conditioning, autonomous driving features, available seats, trunk space, hot tubs, airport drop-off, etc.), location (e.g., city), and so forth.

In various implementations including the filtering functionality, the scheduling interface 120 and calendar visual 128 are designed to display only filter options that are relevant to the property listings 122. By way of example, if the property listings 122 only include luxury and electric vehicles, the only displayed filter options for a ‘vehicle type’ are ‘luxury’ and ‘electric’, instead of including other vehicle types that are not ‘luxury’ or ‘electric’ vehicle types. In various examples, the filters automatically detect options based on the property listings 122 associated with the host account 126 and display only those filter options that are applicable or relevant to the property listings 122. Moreover, by default, the listing manager module 130 filters out the property listings 122 that are not live, such as unlisted and snoozed the property listings 122, to provide a streamlined view of active listings for the host account 126.

The scheduling interface 120 includes functionality to receive and automatically maintains the selections of time periods for the property listings 122 that are received via the user input 304 during a session of the host account 126. The scheduling interface 120, as part of the listing manager module 130, is configured to recognize particular gestures to select the time periods for the property listings 122 that are received via the user input 304. The scheduling interface 120 is configured to receive one or more recognized gestures as part of the selection process.

In some examples, a single tap of a date (e.g., a date cell that corresponds to a specific property listing 122, a date that corresponds to a date column of the calendar visual 128 that corresponds to the property listings 122 of the date column, etc.) is recognized as selecting an individual date, a single tap of a first date and then a long press of a second date is recognized as selecting the first date and the last date and all of the days and times in between the first date and the last date, a single click on a first date followed by a second click on a second date performed in parallel with a ‘shift’ click is recognized as selecting the first date and the last date and all of the days and times in between the first date and the last date, and so forth. By recognizing such gestures as the user input 304, the listing manager module 130 prevents poor user experiences and computational inefficiencies associated with conventional tap-and-drag techniques, which are difficult to use on devices with limited display screens, such as smartphones. The selection techniques via the recognized gestures can be repeated for a plurality of property listings of the property listings 122 or multiple time periods for a single property listing of the property listings 122.

In some implementations, the scheduling interface 120 is configured to receive selections (such as the selection techniques described above and throughout) for time periods for non-consecutive days for all of the property listings 122 simultaneously by selecting various non-consecutive dates at the top of the calendar visual 128 instead of selecting date cells corresponding to specific property listings 122. By way of example, selecting the dates of December the 25th and December the 28th at the top of the date columns of the calendar visual 128, all of the property listings 122 of the date columns of December the 25th and December the 28th are selected for modification for the time period of December the 25th and December the 28th. As already discussed, various recognized gestures or user inputs 304 can be repeated or combined to select different property listings for different time periods until the host account 126 has provided all of the selections of the time periods for the property listings 122 that the host account 126 seeks to apply modifications to via the scheduling interface 120.

In some implementations in which a filtering setting is applied to the scheduling interface 120, when bulk selection techniques are applied, such as to the December the 25th and December the 28th example noted above, the scheduling interface 120 applies the selection technique to only the property listings 122 filtered and presented via the scheduling interface 120. In this way, enhanced user interface of the scheduling interface 120 enables effective bulk selection techniques that are applied to collections of the property listings 122 that are curated via the filtering options applied.

The scheduling interface 120 is configured to have additional functionality to support frictionless selection of settings corresponding to the scheduling interface 120 and of time periods for the property listings 122. By way of example, the calendar visual 128 and the scheduling interface 120 may utilize asynchronous saving, which enables the host accounts 118 to edit time-specific components 124 of the property listings 122 (e.g., prices of a vehicle) other than those that the property hosting application 110 is updated from a previous request or action by the host account 126. Overall, the ‘saving’ features of the calendar visual 128 and the scheduling interface 120 enable the host accounts 118 to continue making changes to the calendar visual 128 and the scheduling interface 120 while the property hosting application 110 saves the previously made modifications, adjustments, or edits in real time.

The listing manager module 130, including the user interface module 204, is configured to receive additional user input 304 selecting modifications to apply to the selections of the time periods selected for the property listings selected of the property listings 122. The scheduling interface 120 provides various functionality to select modifications to apply to the selections, such as price modifications, availability modifications, discount modifications, and so forth. In some examples, the scheduling interface 120 includes a modification section, such as a price modification section. Examples of the modification section include partially hideable modification sections for efficient use of the user interface and other user elements. The modification sections may provide various modification options, such as a fixed or set modification (e.g., setting all prices to the same value for the selections), a flexible or adjustment modification (e.g., adjusting a price by a specified amount or percentage for the selections), a recommended modification (e.g., modifying the prices for the selections to recommended prices by the property hosting application 110), and so forth.

To continue this example system 300, the user interface module 204 is configured to generate modification data 306 based on the user input 304. In some examples, the modification data 306 describes modifications to apply to one or more time-specific components 124 of the property listings 122 (e.g., via modifications to the property listing data 116), such as price modifications or listing status modifications specified by the user input 304 to one or more property listings 122.

By way of example, the modification data 306 may describe a modification to apply to the prices of the selections (the respective time periods selected for the property listings selected) to ‘recommended prices’, in which the ‘recommended prices’ are set by the property hosting application 110 or the property hosting application 110. In some examples, the modification data 306 is time-specific modification data. By way of example, responsive to the user input 304 specifying a time-specific modification, the user interface module 204 is configured to generate time-specific modification data. The user interface module 204 communicates the modification data 306 to the visualization module 206. In some examples, the scheduling interface 120 displays both unadjusted and adjusted time-specific components 124 of the property listings 122 simultaneously as reference for the host accounts 118.

The scheduling interface 120 is configured to include functionality to detect recognized user input (e.g., the user input 304) for applying the modifications to the selections: the respective selected time periods for the selected property listings of the property listings 122. In some examples, the scheduling interface 120 includes one or more selectable user elements, such as a selectable button, to receive the user input 304. As discussed throughout, the user interface module 204 is configured to receive such user input (e.g., the user input 304) and to generate the modification data 306 based on the user input 304.

In some implementations, the user interface module 204, as part of the generation of the modification data 306, detects dates of the selections that have preexisting reservations or bookings as booked dates. The user interface module 204 generates the modification data 306 at least in part based on the booked dates, such that the modification data 306 does not describe modifications to apply to data corresponding to the booked dates, such that only unbooked dates of the property listings are modified by the property hosting application 110.

The visualization module 206 is configured to receive the modification data 306 from the user interface module 204 and to generate modified visuals 302 corresponding to the scheduling interface 120 and the calendar visual 128 based on the modification data 306. Based on the modification data 306, the visualization module 206 and the rendering module 208 of the visualization module 206 generate and render the modified visuals 302 by generating modified rendering data 308 representing at least the modified visuals 302. In some examples, the modified rendering data 308 includes a modified scheduling interface and a modified calendar visual.

The rendering module 208 is configured to communicate the modified rendering data 308 to the user interface module 204. The user interface module 204, as with the visuals 210, outputs the modified visuals 302 for display via the user interface of the computing device 106. In some examples, the user interface module 204 outputs the modified visuals 302 for display via the user interface of the computing device 106 as part of the scheduling interface 120 and the calendar visual 128, or as part of modified versions of the scheduling interface 120 and the calendar visual 128.

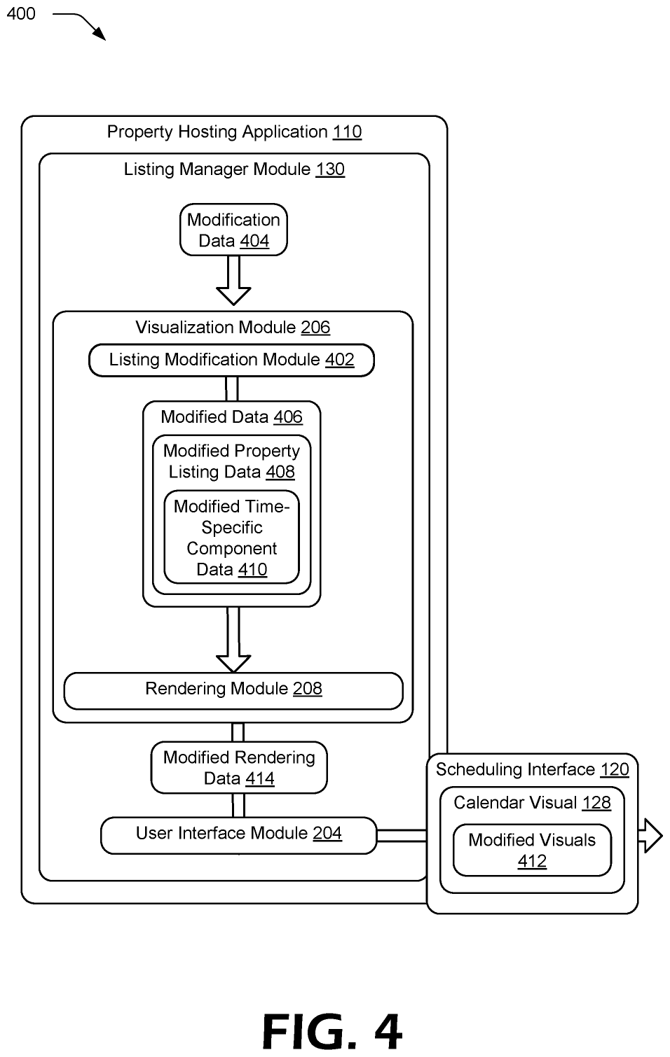

In the context of modifying time-specific components 124 of property listings 122 simultaneously, consider the following discussion of FIG. 4.

FIG. 4 depicts a system 400 in an example implementation showing operation of a listing manager module 130 for modifying time-specific components 124 of property listings 122 simultaneously based on modification data 404 and by rendering modified visuals 412 representing the modified time-specific components 124 corresponding to the property listings 122. The listing manager module 130 depicted includes the visualization module 206 of FIG. 2, in which the visualization module 206 includes a listing modification module 402 and the rendering module 208. The listing modification module 402 is configured to modify the property listings 122 of the property listing data 116 and to generate modified data 406 corresponding to the corresponding modifications. The listing manager module 130 further includes the user interface module 204 of FIG. 2.

To begin this example, the visualization module 206 receives modification data 404. In some examples, the visualization module 206 receives the modification data 404 from the user interface module 204, which generates the modification data 404 based on the user input 304. The modification data 404, like the modification data 304 of FIG. 3, describes modifications. In this example 400, the modification data 404 describes modifications to apply to the property listings 122 for selections specified by the user input 304.

Based on the modification data 404, the listing modification module 402 of the visualization module 206 is configured to generate modified data 406 based on the modification data 404. In some examples, the modified data 406 is generated in part based on the property listing data 116. The modified data 406 includes modified property listing data 408, in which the modified property listing data 408 includes modified time-specific component data 410. The listing modification module 402 is further configured to communicate the modified data 406 to the rendering module 208.

As already discussed in this description, the rendering module 208, as part of the visualization module 206, is configured to generate modified rendering data 414 based on the modified data 406. The modified rendering data 414 includes one or more of the modified visuals 412 generated based on the modified data 406. The modified rendering data 414 includes information for rendering the modified visuals 412 generated by the visualization module 206. In some examples, the modified rendering data 414 includes information for rendering the scheduling interface 120, the calendar visual 128, and the modified visuals 412. In various examples, the modified rendering data 414 includes information for rendering modified versions of the scheduling interface 120 and the calendar visual 128. The rendering module 208 communicates the modified rendering data 414 to the user interface module 204.

The user interface module 204 receives the modified rendering data 414. Based on the modified rendering data 414, the user interface module 204 renders the modified visuals 412 for display via the user interface of the computing device 106. In some examples, the user interface module 204 renders the modified visuals 412 as part of the scheduling interface 120 and the calendar visual 128 for display via the user interface of the computing device 106.

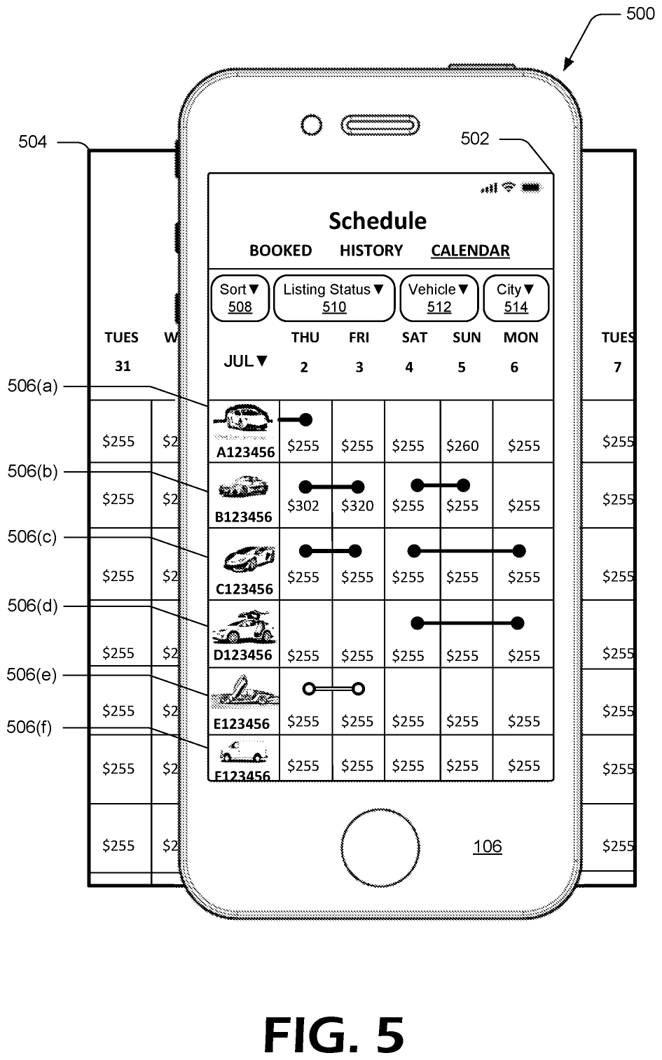

In the context of modifying time-specific components 124 of property listings simultaneously, consider the following discussion of FIG. 5.

FIG. 5 depicts an example 500 of rendering a scheduling interface 502 including a calendar visual 504 presenting schedules of property listings 506 associated with a host account of an online platform. This example 500 depicts the computing device 106, in which a user interface of the computing device displays the rendered scheduling interface 502. The rendered scheduling interface 502 includes a calendar visual 504. The calendar visual 504 presents schedules of property listings 506 (including at least property listings 506(a)-(f), which are depicted as being visible via the current view of the user interface of the computing device 106) associated with one or more host accounts 118 associated with the online platform. The scheduling interface 502 is configured to move the viewed position of the calendar visual 504 via various recognized gestures, such as scrolling or swiping.

In this example 500, the computing device 106 is a smartphone of the host account 126. The scheduling interface 502 includes selectable visual elements 508, 510, 512, and 514 for sort options 508, listing status 510, vehicle 512, and city 514. In some examples, the scheduling interface 502 includes additional selectable visual elements, such as various filtering options. The various filtering options (e.g., vehicle 512, etc.) facilitate the organization and presentation of property listings according to various parameters, such as listing status, property type, location (e.g., city 514), host account (e.g., comparing one host account to another), price, and other specific details.

The scheduling interface 502, the calendar visual 504, and the schedules corresponding to the property listings 506 are rendered based on property listing data 116 corresponding to the host account 126. The calendar visual 504 includes visuals representing time-specific components 124 of the property listings 506, such as the prices of the property listings 506 at any given time period, the listing status of the property listings 506 at any given time period, and so forth. By way of example, property listing 506(b) includes solid black bars indicating that the property listing 506(b) is reserved on July the second through the fifth by two different reservations. In this example 500, the solid black bars are visuals that indicate confirmed reservations of a property listing 506 for a given period of time marked on the calendar visual 504. In some examples, one or more of the visuals of the calendar visual 504 indicate confirmed reservations of a property listing 506 for a portion of a date. By way of example, if the property listing 506(b) is reserved from 6 pm on July the second through 12 pm of July the fifth, the calendar visual 504 may be configured to include a visual that partially blocks the dates of the time period to indicate the given time period between 6 pm on July the second and 12 pm on July the fifth.

By way of a different example, property listing 506(f) is depicted as being unavailable on July the second and third by a hollow bar indicating that at least one of the one or more host accounts 118 made the property listing unavailable during the second and third of July, and therefore not reservable. In this example 500, hollow bars are visuals that indicate an unavailability of a property listing 506 for a given period of time marked on the calendar visual 504. In some examples, the visual indicating that the property listing 506(f) is unavailable for a given time period is configured to partially block the dates of the time period to indicate the corresponding time components (e.g., 6 pm, 12 pm, and so forth) of the given time period.

Other visuals are imagined, such as visuals representing an available day, a pending reservation request, and so forth. As an example of a visual representing an available day, the absence of a visual, such as a solid black bar, over a time period in the calendar visual 504, indicates that the property listing is available (and not reserved by a guest account) during the corresponding time period. By way of example, because there is no visual depicted over the second and third of July for property listing 506(d) of the calendar visual 504, property listing 506(d) is available for reservation by a guest account of the online platform during the second and third of July. Examples of visuals include a dashed black bar visual that represents a pending reservation request for a property listing for a time period, a hollow bar visual that represents an unavailability of the property listing for a time period, and so forth.

The calendar visual 504 and the scheduling interface 502 enables host accounts 118 to seamlessly navigate across periods of time (e.g., dates) and property listings 122 represented or presented via the calendar visual 504. By way of example, a user element can be selected via a user input 304 of the host account 126 to navigate to the current date. By way of example, the calendar visual 504 is configured to enable the host account to navigate to view the schedules of the 31st of June, the 7th of July, and other schedules that are not initially visible via the small user interface of the computing device 106.

The calendar visual 504 is configured to enable host accounts 118 to navigate forward or backward over long periods of time via a month-view of the calendar visual 504 by jumping to a chosen date. In this example 500, the host account can navigate forward or backward over long period of time by providing user input 304 to the selectable month option (which depicts “JUL” as the currently selected month option) to select a different month, such as “DEC” or “December”. There are various other techniques to seamlessly navigate across the dates and property listings 122.

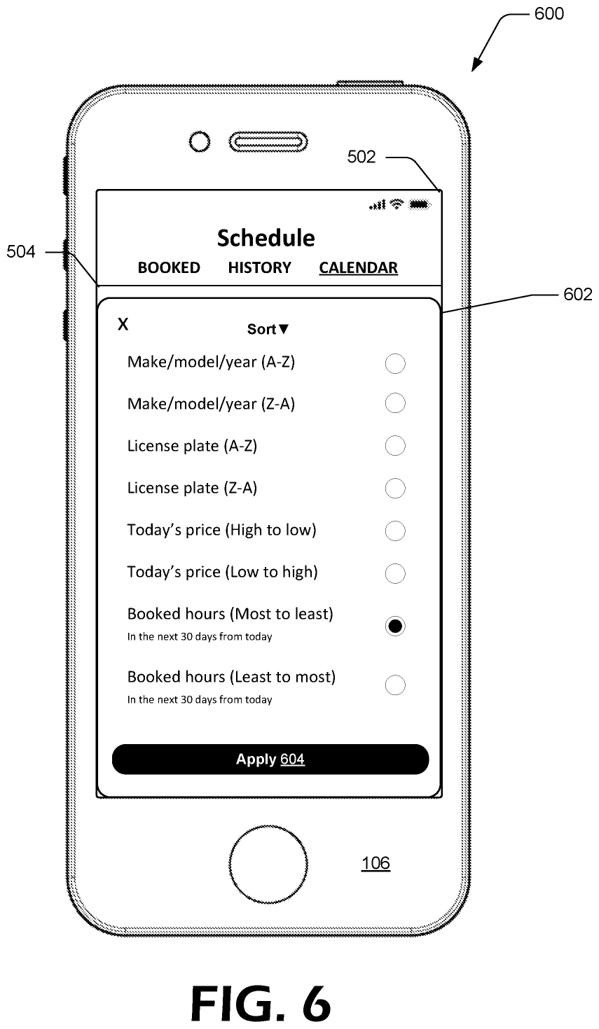

In the context of sorting the property listings presented via the scheduling interface 502 of FIG. 5, consider the following discussion of FIG. 6.

FIG. 6 depicts an example 600 of the scheduling interface 502 of FIG. 5, in which the scheduling interface 502 includes a plurality of selectable sorting options 602 to apply to the schedules of the property listings 506 presented by the calendar visual 504 of the scheduling interface 502. In this example 600, the computing device 106 displays the scheduling interface 502 and the calendar visual 504 of FIG. 5.

The scheduling interface 502 and the calendar visual 504 are obscured in part by the plurality of selectable sorting options 602. Plurality of selectable sorting options 602 includes options to sort by make/model/year (A-Z), make/model/year (Z-A), license plate (A-Z), license plate (Z-A), today's price (high to low), today's price (low to high), booked hours in the next thirty days from today (most to least), and booked hours in the next thirty days from today (least to most). The plurality of selectable sorting options 602 includes a selectable visual element 604 to apply the sorting options to the schedules of the property listings 506 presented by the calendar visual 504.

The selectable visual element 604 is selectable via user input 304. Various other sorting options are imagined, as already described in this description. In this example 600, the “Booked hours (Most to least)” sorting option in selected of the plurality of selectable sorting options 602. After receiving a user input 304 via the “Apply” selectable visual element 604, the property listings 506 are sorted such that the property listings 506 with the most booked hours in the next thirty days from today are presented at the top of the calendar visual 504 and the property listings 506 with the least booked hours in the next thirty days from today are presented at the bottom of the calendar visual 504.

By way of example, since there are more property listings 506 than can be viewed in the small user interface of the computing device 106 without additional scrolling, the property listing 506 with the least booked hours is not initially viewable without providing additional user input 304 to scroll down through the property listings 506 presented by the calendar visual 504.

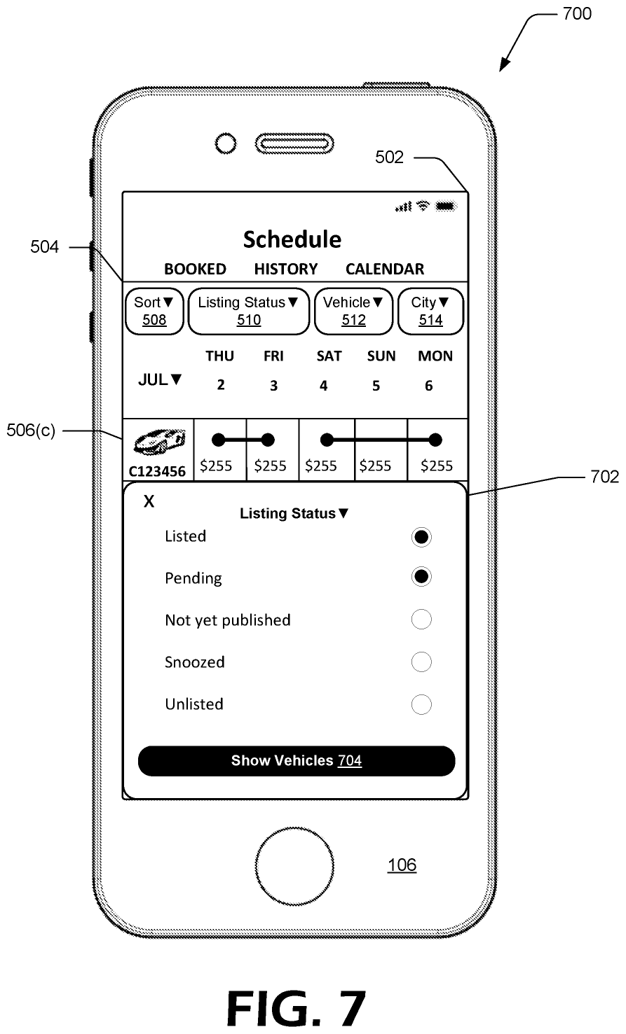

In the context of filtering the property listings 506 of FIG. 5, consider the following discussion of FIG. 7.

FIG. 7 depicts an example 700 of the scheduling interface 502 of FIG. 5 including a plurality of selectable filtering options 702 to apply to the schedules of the listing properties 506 presented by the calendar visual 504 of the scheduling interface 502. In this example 700, the computing device 106 displays the calendar visual 504 and the scheduling interface 502 of FIG. 5. The selectable visual element 510 of FIG. 5 is selected in the scheduling interface 502, thus presenting a plurality of selectable filtering options 702 for filtering based on the listing status of the property listings 506. The plurality of selectable filtering options 702 includes listed, pending, not yet published, snoozed, and unlisted statuses to filter the property listings 506 with.

In this example 700, the “Listed” and “Pending” statuses are selected for sorting. After the user interface of the computing device receives a selection of the selectable visual element 704, the window presenting the plurality of selectable filtering options 702 is removed from the view of the scheduling interface 502 and the property listings 506, as filtered, are displayed. In summary, the calendar visual 504, based on the selection of the “Listed” and “Pending” statuses and the selectable visual element 704, presents only the listed and pending property listings 506, including property listing 506(c).

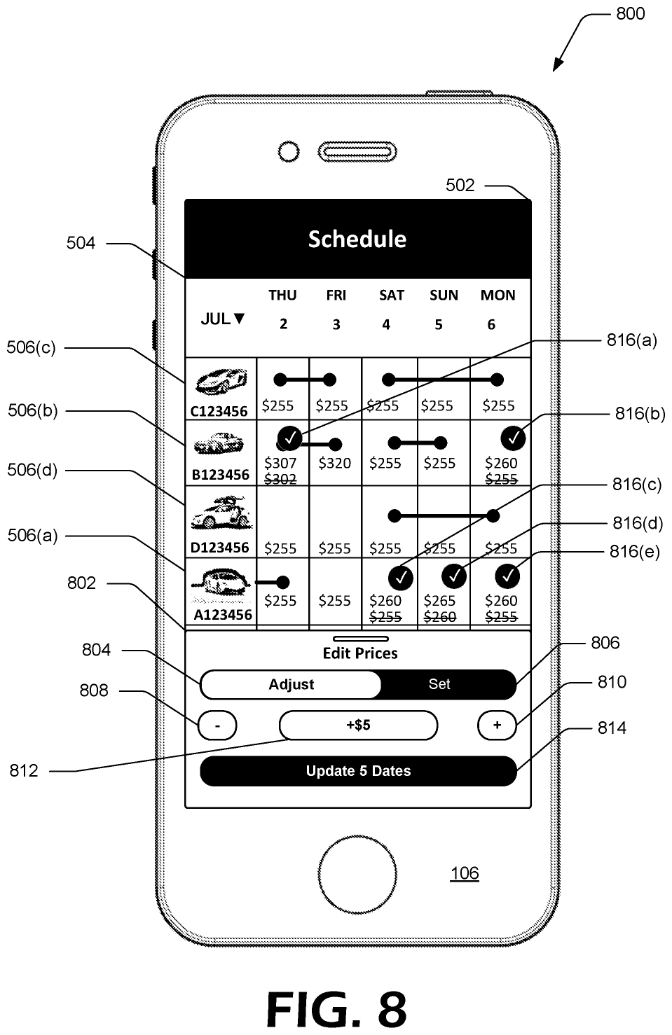

In the context of initiating modification of time-specific components 124 of the property listings 506 simultaneously, consider the following discussion of FIG. 8.

FIG. 8 depicts an example 800 of user input 304 selecting time periods for property listings via the calendar visual 504 and scheduling interface 502 of FIG. 5. This example 800 depicts the computing device 106 displaying the scheduling interface 502 and the calendar visual 504 of FIG. 5, in which the calendar visual 504 presents the schedules of the property listings 506.

Selections by the host account 126 are represented by the black circles including white checkmarks within the black circles, in which the visual representations of the selections overlay the calendar visual 504. In some examples, the selection of the time periods (e.g., time periods 816(a)-(e)) are indicated by objects or other visual representations of the selections, such as the illustrated black circles including the white checkmarks. Some examples of objects or other visual representations of selections by the host account or the host accounts include icons, checkboxes, and so forth.

As discussed throughout, the selections of the time periods selected for the property listings 506 selected are received via user input 304 via the user interface of the computing device 106. By way of example, the listing manager module 130 (e.g., the user interface module 204) is configured to receive the user input 304.

In this illustrated example 800, the user input 304 is provided as a first individual short tap on a first cell representing July the second for the property listing 506(b), a second individual short tap on a second cell representing July the sixth for the property listing 506(b), a third short tap on a third cell representing July the fourth for the property listing 506(a), and a fourth long tap on a fourth cell representing July the sixth for the property listing 506(a).

By receiving the four recognized selection techniques via the user input 304 in a single modification session (as illustrated by FIGS. 5-9) without yet providing additional user input 304 to apply modifications to the selections, the scheduling interface 502 is configured to receive additional selection techniques via the additional user input 304 to add additional selections or to remove one or more of the selections illustrated in this example 800 via the calendar visual 504. In some examples, the additional user input 304 is one tap received via the user interface of the computing device 106, in which the one tap cancels out of one or more selections and thus removes the one or more selections.

The calendar visual 504 is partially obscured by a window 802 for modifying a time-specific component of the property listings 506: the price of the property listings 506 during time periods. The window 802 includes selectable visual elements 804 and 806 to specify a price adjustment modification (adjusting by a host account-specified currency amount or cryptocurrency amount, or by a host account-specified percentage, by way of example), or a set price modification in which the price of the specified property listings for the specified time periods are modified to the set value specified in the window 802.

To continue this example 800, the window 802 specifies the price adjustment modification via the selectable visual element 804. The window 802 is further configured to display selectable visual elements 808 and 810, which are easily selectable via user input 304 to increase the amount 812 specified to apply as a modification to the time-specific components 124 of the property listings 506.

The current amount 812 specifies modifying the selected property listings 506(b) and 506(a) by increasing the price of the property listings 506(b) and 506(a) by five United States dollars. The window 802 further includes a selectable visual element 814 for applying the modification specified by the amount 812 to the time-specific components 124 of the property listings 506(b) and 506(a) for the time periods 816(a)-816(e) selected via user input 304 for the respective property listings 506(b) and 506(a). Based on the five United States dollar price modification specified, the calendar visual 504 is configured to present the proposed modified prices in addition to the unmodified prices.

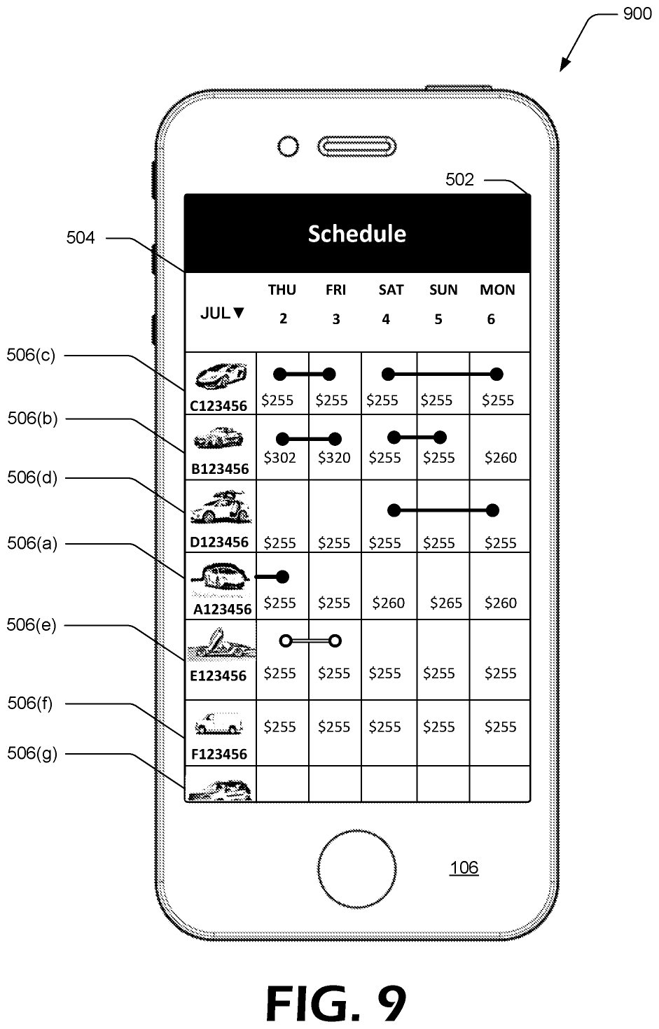

In the context of techniques for simultaneously modifying time-specific components 124 of the property listings 506, consider the following discussion of FIG. 9.

FIG. 9 depicts an example 900 of modifying time-specific components 124 of the property listings 506 simultaneously by applying the modifications specified by the user input 304 in FIG. 8. This example 900 depicts the computing device 106 in which the computing device 106 depicts the scheduling interface 502, the calendar visual 504, and the property listings 506 of FIG. 5.

The calendar visual 504 includes modified visuals generated based on the modifications and the selections 816 specified by the user input 304 in FIG. 8. The modified visuals include the $260 price presented for the sixth of July for the property listing 506(b), the $255 price presented for the fourth of July for the property listing 506(a), the $260 price presented for the fifth of July for the property listing 506(a), and the $255 price presented for the sixth of July for the property listing 506(a).

Although the example 800 depicted a specified modification of a price change to the price of the property listing 506(b) for the second of July, the example 900 depicts the price as unchanged. Here, the price for of the property listing 506(b) for the second of July is unchanged because the property listing 506(b) is already reserved by a guest account for the second of July.

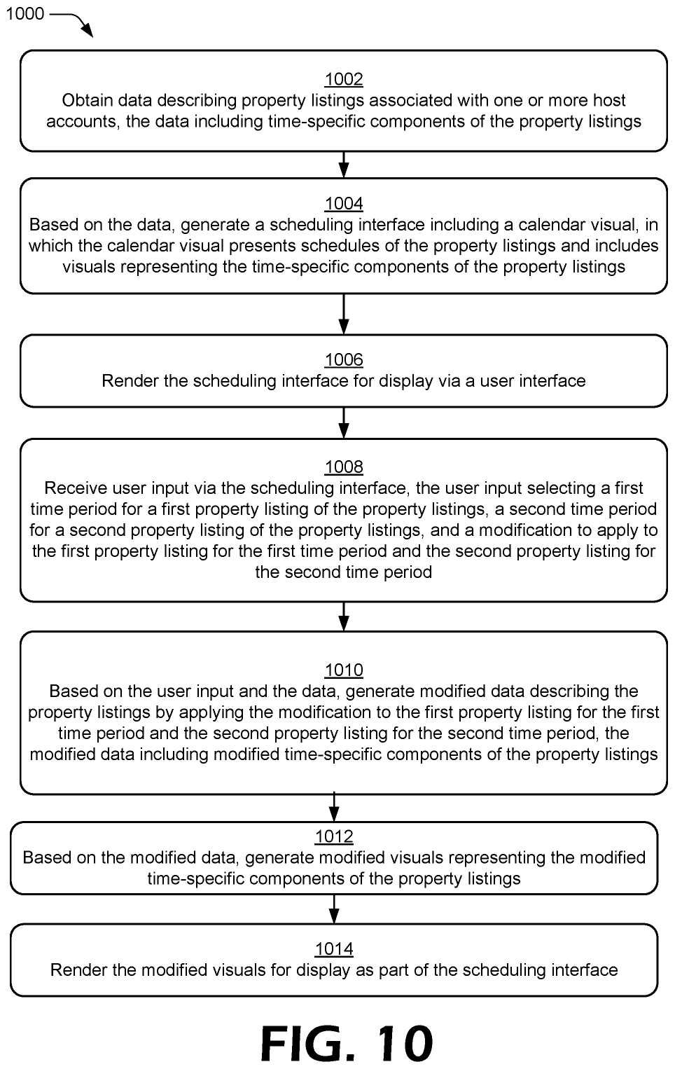

In the context of modifying time-specific components 124 of property listings simultaneously, consider the following discussion of FIG. 10.

### Example Procedures

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-9.

FIG. 10 depicts a procedure 1000 in an example implementation of modifying time-specific components 124 of property listings 122 simultaneously.

As depicted by block 1002, data 114 describing property listings 122 associated with one or more host accounts is obtained, the data including time-specific components 124 of the property listings. By way of example, the listing manager module 130 is configured to obtain data 114, including the property listing data 116. In some implementations, the listing manager module 130 obtains the property listing data 116 as part of the data 114. The property listing data 116 includes time-specific components 124. Examples of time-specific components 124 include but are not limited to a price of reserving a property listing 122, an availability of a property listing 122, and so forth.

In some implementations, the property listing data is received from various sources, such as from the computing device 106, from the property hosting application 110, from the property hosting platform 104, from one or more different applications (e.g., different property hosting applications), from one or more different platforms (e.g., different property hosting platforms), and so forth.

As depicted by block 1004, based on the data, a scheduling interface including a calendar visual is generated, in which the calendar visual presents schedules of the property listings and includes visuals representing the time-specific components 124 of the property listings 122.

By way of example, based on the property listing data 116, the visualization module 206 generates a scheduling interface 120 including a calendar visual 128. The calendar visual 128 presents schedules of the property listings 122 based on the property listing data 116 and includes visuals 210 representing the time-specific components 124 of the property listings. In some implementations, the visualization module 206 generates the scheduling interface 120, the calendar visual 128, and the visuals 210 based in part on the data 114.

As depicted by block 1006, the scheduling interface is rendered for display via a user interface. By way of example, as part of the visualization module 206, the rendering module 208 generates rendering data 212 corresponding to the scheduling interface 120, the calendar visual 128, and the visuals 210 generated by the visualization module 206. The visualization module 206 is configured to communicate the rendering data 212 to the user interface module 204 to display the scheduling interface 120, the calendar visual 128, and the visuals 210 rendered via a user interface of the computing device 106.

In some examples, the calendar visual 128 includes enhanced scrolling, such that host accounts do not need to wait for each batch of consecutive data (e.g., property listings 122 presented via the calendar visual 128 or dates of the calendar visual 128) to load. The scheduling interface 120 is configured to move the viewed position of the calendar visual 128 via various recognized gestures, such as scrolling or swiping.

Once a host account 126 stops at a particular portion of the calendar visual 128 for at least a predefined time period designated by the property hosting application 110, the property hosting application 110 fetches an additional portion of the data 114 corresponding to where the host account 126 has stopped, in which the additional portion of the data 114 corresponds to the visible portion of the calendar visual 128. As such, in some examples, the host account 126 can begin providing user input 304 to modify time-specific components 124 of the property listings 122 before the fetching of the data 114 is complete.

As depicted by block 1008, user input 304 is received via the scheduling interface 120, the user input 304 selecting a first time period for a first property listing of the property listings 122, a second time period for a second property listing of the property listings 122, and a modification to apply to the first property listing for the first time period and the second property listing for the second time period. As discussed throughout the user interface module 204 and the listing manager module 130 are configured to receive the user input 304 304 via the scheduling interface 120.

By way of example, in illustrated example 800, the user input 304 is provided as a first individual short tap on a first cell representing July the second for the property listing 506(b), a second individual short tap on a second cell representing July the sixth for the property listing 506(b), a third short tap on a third cell representing July the fourth for the property listing 506(a), and a fourth long tap on a fourth cell representing July the sixth for the property listing 506(a). To summarize, the user input 304 provided as an example 800 in FIG. 8 selects at least a first time period for a first property listing and a second time period for a second property listing as the selections 816.

Illustrated example 800 further depicts a (adjustment price) modification of an additional five United States dollars to apply to the selections 816 of at least the first time period for the first property listing and the second time period for the second property listing, in addition to a third time period for the first property listing. In some implementations, the modification selected (e.g., an adjustment price modification, a set price modification, etc.) may be a modification recommended by the property hosting application 110.

As depicted by block 1010, based on the user input 304 and the data 114, modified data describing the property listings 122 is generated by applying the modification to the first property listing for the first time period and the second property listing for the second time period, the modified data including modified time-specific components of the property listings 122. By way of example, the listing modification module 402 generates the modified data 406 based at least in part on the modification data 404 describing the modifications specified for the selections by the user input 304 received via the scheduling interface.

As discussed throughout, the modified data 406 describes the property listings and is generated by the visualization module 206 based on the selections and the data 114 (including the property listing data 116), such as the first time period for the first property listing and the second time period for the second property listing, and the modified data includes the modified time-specific components of the property listings. By way of example, the modified data 406 includes the modified property listing data 408 and the modified time-specific component data 410.

As depicted by block 1012, based on the modified data, modified visuals are generated, the modified visuals representing the modified time-specific components of the property listings. By way of example, the rendering module 208, as part of the visualization module, generates modified rendering data 414 based on the modified data 406. The modified rendering data 414 includes one or more of the modified visuals 412 generated based on the modified data 406. The modified rendering data 414 includes information for rendering the modified visuals 412 generated by the visualization module 206.

As depicted by block 1014, the modified visuals are rendered for display as part of the scheduling interface. As discussed throughout, the user interface module 204 renders the modified visuals 412 for display as part of the scheduling interface 120. By way of example, the illustrated example 900 depicts the modified visuals as modified prices via the calendar visual 504 and the scheduling 502. To continue the illustrated example 900, the modified visuals depicted include the $260 price presented for the sixth of July for the property listing 506(b), the $255 price presented for the fourth of July for the property listing 506(a), the $260 price presented for the fifth of July for the property listing 506(a), and the $255 price presented for the sixth of July for the property listing 506(a).

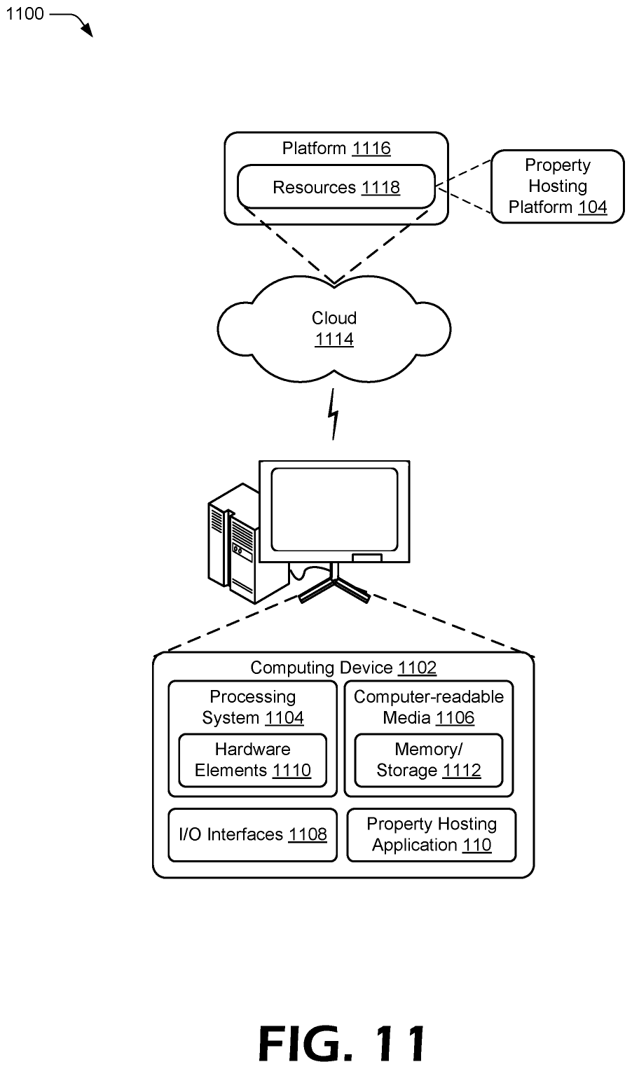

Overall, the enhanced user interface of the scheduling interface addresses the issues of conventional property hosting, such as diminished user satisfaction and wasted computational power, storage, and transmission resources. Instead, the enhanced user interface of the scheduling interface results in increased user satisfaction, and more efficient use of computational power, storage, and transmission resources. In the context of modifying time-specific components 124 of property listings 122 simultaneously, consider the following discussion of FIG. 11.

### Example System and Device

FIG. 11 illustrates an example system generally at 1100 that includes an example computing device 1102 that is representative of one or more computing systems and/or devices that implement the various techniques described herein. This is illustrated through inclusion of the property hosting platform 104 and the property hosting application 110. The computing device 1102 is configurable, for example, as a server of a service provider, a device associated with a client (e.g., a client device), an on-chip system, and/or any other suitable computing device or computing system.

The example computing device 1102 as illustrated includes a processing system 1104, one or more computer-readable media 1106, and one or more I/O interface 1108 that are communicatively coupled, one to another. Although not shown, the computing device 1102 further includes a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1104 is representative of functionality to perform one or more operations using hardware. Accordingly, the processing system 1104 is illustrated as including hardware element 1110 that is configurable as processors, functional blocks, and so forth. This includes implementation in hardware as an application specific integrated circuit or other logic device formed using one or more semiconductors. The hardware elements 1110 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1106 is illustrated as including memory/storage 1112. The memory/storage 1112 represents memory/storage capacity associated with one or more computer-readable media. The memory/storage 1112 includes volatile media (such as random access memory (RAM)) and/or nonvolatile media (such as read only memory (ROM), Flash memory, optical disks, magnetic disks, and so forth). The memory/storage 1112 includes fixed media (e.g., RAM, ROM, a fixed hard drive, and so on) as well as removable media (e.g., Flash memory, a removable hard drive, an optical disc, and so forth). The computer-readable media 1106 is configurable in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1102 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1102. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1102, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1110. The computing device 1102 is configured to implement particular instructions and/or functions corresponding to the software and/or hardware modules. Accordingly, implementation of a module that is executable by the computing device 1102 as software is achieved at least partially in hardware, e.g., through use of computer-readable storage media and/or hardware elements 1110 of the processing system 1104. The instructions and/or functions are executable/operable by one or more articles of manufacture (for example, one or more computing devices and/or processing systems 1104) to implement techniques, modules, and examples described herein.

The techniques described herein are supported by various configurations of the computing device 1102 and are not limited to the specific examples of the techniques described herein. This functionality is also implementable through use of a distributed system, such as over a “cloud” 1114 via a platform 1116 as described below.

The cloud 1114 includes and/or is representative of a platform 1116 for resources 1118. The platform 1116 abstracts underlying functionality of hardware (e.g., servers) and software resources of the cloud 1114. The resources 1118 include applications and/or data that can be utilized while computer processing is executed on servers that are remote from the computing device 1102. Resources 1118 can also include services provided over the Internet and/or through a subscriber network, such as a cellular or Wi-Fi network.

The platform 1116 abstracts resources and functions to connect the computing device 1102 with other computing devices. The platform 1116 also serves to abstract scaling of resources to provide a corresponding level of scale to encountered demand for the resources 1118 that are implemented via the platform 1116. Accordingly, in an interconnected device embodiment, implementation of functionality described herein is distributable throughout the system 1100. For example, the functionality is implementable in part on the computing device 1102 as well as via the platform 1116 that abstracts the functionality of the cloud 1114.

What is claimed is:

1. A method comprising:
receiving, by a computing device, data describing property listings associated with a host account of an online platform and time-specific components corresponding to the property listings;
based on the data, generating, by the computing device, a scheduling interface including a calendar visual, in which the calendar visual presents schedules of the property listings and includes visuals representing the time-specific components of the property listings;
rendering, by the computing device, the scheduling interface for display via a user interface;
receiving, by the computing device, user input via the scheduling interface, the user input selecting different time periods for different property listings and a time-specific modification to apply to the different property listings for the different time periods;
based on the user input and the data, generating, by the computing device, modified data describing the property listings associated with the host account of the online platform by applying the time-specific modification to the different property listings for the different time periods, the modified data including modified time-specific components of the property listings;
based on the modified data, updating, by the computing device, the visuals to modified visuals representing the modified time-specific components of the property listings; and
rendering, by the computing device, the modified visuals for display via the user interface as part of the calendar visual and the scheduling interface.

2. The method of claim 1, wherein the scheduling interface includes a plurality of selectable sort options for sorting the schedules of the property listings.

3. The method of claim 2, wherein the plurality of selectable sort options includes at least one sort option of a make, model, year, license plate, price, trip days in an upcoming thirty day time period, and booked hours.

4. The method of claim 2, further comprising:
receiving, by the computing device, a selection of a selectable sort option of the plurality of selectable sort options; and
sorting, by the computing device, the schedules of the property listings based on the selection of the selectable sort option.

5. The method of claim 1, wherein the scheduling interface includes a plurality of selectable filtering options for filtering the schedules of the property listings based on the data describing the property listings.

6. The method of claim 5, wherein the plurality of selectable filtering options includes at least one of property, location, and listing status.

7. The method of claim 5, wherein the generating of the scheduling interface further comprises identifying, by the computing device, irrelevant filter options based on the data describing the property listings, and wherein the plurality of selectable filtering options do not include the irrelevant filter options.

8. The method of claim 5, further comprising:
receiving, by the computing device, user input selecting one or more of the plurality of selectable filter options; and
based on the one or more selectable filter options selected, filtering, by the computing device, the schedules of the property listings presented by the calendar visual.

9. The method of claim 6, wherein the listing status includes at least one of listed, pending, not yet published, snoozed, unlisted, and deactivated.

10. The method of claim 1, wherein the different time periods include non-consecutive days.

11. A system comprising:
a memory component; and
a processing device coupled to the memory component, the processing device to perform operations comprising:
receiving data describing property listings associated with one or more host accounts of an online platform, the data including time-specific components of the property listings;
based on the data, generating an interactive scheduling interface including a calendar visual, in which the calendar visual presents schedules of the property listings and includes visuals representing the time-specific components of the property listings;
rendering the interactive scheduling interface for display via a user interface;
receiving user input via the interactive scheduling interface, the user input selecting a first time period for a first property listing of the property listings, a second time period for a second property listing of the property listings, and a time-specific modification to apply to the first property listing for the first time period and the second property listing for the second time period;
based on the user input and the data, generating modified data describing the property listings associated with the one or more host accounts of the online platform by applying the time-specific modification to the first property listing for the first time period and the second property listing for the second time period, the modified data including modified time-specific components of the property listings;
based on the modified data, updating the visuals to modified visuals representing the modified time-specific components of the property listings; and
rendering the modified visuals.

12. The system of claim 11, wherein a default filter of the interactive scheduling interface filters out one or more schedules for the property listings that are at least one of not listed, pending, and not yet published.

13. The system of claim 11, wherein the user input via the interactive scheduling interface includes a third time period for the first property listing of the property listings, and the generating of the modified data includes applying the time-specific modification to the first property listing for the third time period.

14. The system of claim 11, wherein the modification is a price modification.

15. The system of claim 14, wherein the price modification is a fixed price modification.

16. The system of claim 14, wherein the price modification is a price adjustment modification.

17. The system of claim 14, wherein the price modification is a recommended price modification in which the recommended price modification is provided by the online platform.

18. The system of claim 11, wherein the time-specific components of the property listings include at least one of booking settings, price settings, listing settings, listing status, bookings, and prices.

19. The system of claim 14, wherein the price modification is limited by at least one of a floor price or a ceiling price set by the one or more host accounts.

20. A non-transitory computer-readable storage medium executable instructions, which when executed by a processing device, cause the processing device to perform operations comprising:
receiving data describing property listings associated with one or more host accounts of an online platform, the data including time-specific components of the property listings;
based on the data an interactive scheduling interface including a calendar visual, in which the calendar visual presents schedules of the property listings and includes visuals representing the time-specific components of the property listings;
rendering the interactive scheduling interface;
receiving user input via the interactive scheduling interface, the user input selecting a first time period for a first property listing of the property listings, a second time period for a second property listing of the property listings, and a time-specific modification to apply to the first property listing for the first time period and the second property listing for the second time period;
based on the user input and the data, generating simulated data describing the property listings associated with the one or more host accounts of the online platform by applying the time-specific modification to the data describing the first property listing for the first time period and the second property listing for the second time period of the property listings, the simulated data including simulated time-specific components of the property listings;
based on the simulated data, updating the visuals to modified visuals representing at least the simulated time-specific components of the property listings; and
rendering the modified visuals as part of the interactive scheduling interface.
